(19) United States
(12) Patent Application Publication
(10) Pub. No.: US 2007/0076614 A1
(43) Pub. Date: Apr. 5, 2007

(54) METHOD FOR CHANGING CHANNELS IN WIRELESS COMMUNICATION TERMINAL AND CONTENT SERVICE SYSTEM

(75) Inventor: Jae-Young CHO, Seoul (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 11/469,667

(22) Filed: Sep. 1, 2006

(30) Foreign Application Priority Data
Sep. 1, 2005 (KR) 10-2005-0081375

(51) Int. Cl. H04J 3/14; H04L 12/26

(52) U.S. Cl. 370/238

(57) ABSTRACT

A method for changing channels in a wireless communication terminal includes requesting real-time content of a first channel from a content service system; receiving and playing the requested real-time content of the first channel after establishing a session with the content service system; requesting channel change from the content service system when a user makes the channel change request; and receiving and playing real-time content of a second channel from the content service system through the session established with the content service system.

### CROSS REFERENCE TO RELATED APPLICATION

This application claims the benefit of and priority to Korean Patent Application No. 2005-81375, filed on Sep. 1, 2005, which is hereby incorporated by reference for all purposes as if fully set forth herein.

### BACKGROUND OF THE INVENTION

1. Field of the Invention

The present invention relates to a method of changing channels in a wireless communication terminal and a method of changing channels in a content service system, which receives and outputs real-time multimedia of a changed channel through an existing session with a content server without returning to a browser when a user makes channel change request during playback of real-time multimedia content of an existing channel that is provided from the content server.

2. Discussion of the Background

A wireless communication terminal implies an electronic handheld telecommunications device, such as mobile phone, PCS (Personal Communications Service) terminal, PDA (Personal Digital Assistant), Smartphone, IMT-2000 terminal, or wireless LAN terminal, that transmits and receives voice, text and image data over wireless telecommunications networks.

Real-time multimedia content may include Digital Multimedia Broadcasting (DMB) content or Voice on Demand (VOD) content that is provided in real time.

FIG. 1 shows a method of changing channels according to the related art.

A wireless communication terminal includes a mobile browser 11 and a content playback unit 12. The mobile browser 11 allows users to select multimedia content in real time. The content playback unit 12 plays the real-time multimedia content received from a content service system.

The content service system includes a server connection unit 13 and a content server 14. The server connection unit 13 is used to establish a session between the wireless communication terminal and the content server 14 providing real-time multimedia content at the request of the wireless communication terminal. The content server 14 provides the real-time multimedia content through the session with the wireless communication terminal that is connected through the server connection unit 13.

A conventional method of changing channels will be described with reference to FIG. 1. When a user requests real-time multimedia content of a first channel, the wireless communication terminal requests the real-time multimedia content of the first channel from the content service system (101).

The server connection unit 13 of the content service system receives the request of the wireless communication terminal (101), and establishes a first session between the wireless communication terminal and the content server 14 (102) and between the content server 14 and the first channel (103). The content server 14 receives the real-time multimedia content of the first channel (104), sends the real-time multimedia content of the first channel to the server connection unit 13 (105), and the server connection unit 13 sends the real-time multimedia content of the first channel to the content playback unit 12 (106) during the first session.

When the user makes channel change request, the wireless communication terminal requests a channel change from the content service system (107 and 108).

The content service system transmits the channel change request to the first channel (109), and the first channel stops providing the multimedia content of the first channel to the wireless communication terminal (110). The content service system releases the first session with the wireless communication terminal. The content service system notifies the wireless communication terminal that the first session has been released (111 and 112).

The wireless communication terminal notifies the user through the mobile browser 11 that the first session has been released. The user then returns to the mobile browser 11, and selects new real-time multimedia content of a second channel.

The server connection unit 13 of the content service system receives the request of the wireless communication terminal to receive real-time multimedia content of a second channel (113). The server connection unit 13 establishes a second session between the wireless communication terminal and the content server 14 (114), and between the content server 14 and the second channel (115) to process the channel change request from the wireless communication terminal. The content server 14 receives the multimedia content of the second channel (116), sends the multimedia content of the second channel to the server connection unit 13 (117), and the server connection unit 13 sends the multimedia content of the second channel to the wireless communication terminal (118) during the second session.

According to the above-mentioned method, when a channel needs to be changed, a wireless communication terminal releases an existing session, returns to a browser and establishes a new session after a new channel is selected by the user. Accordingly, there is a problem in that it takes long time to provide real-time multimedia content and a limited resource of the wireless communication terminal is wasted.

That is, when the wireless communication terminal receives a channel change request from the user during playback of real-time multimedia content provided over a first channel, the wireless communication terminal stops playing the real-time multimedia content, releases the channel, returns to the browser, establishes a new session with a new channel selected by the user, and receives new real-time multimedia content over a second channel. Accordingly, there is a problem in that it takes long time to provide the real-time multimedia content and a limited resource of the wireless communication terminal is wasted.

### SUMMARY OF THE INVENTION

The present invention provides a method of changing channels in a wireless communication terminal, which receives real-time multimedia content of a changed channel through an existing session with a content server without returning to a browser when a channel change is requested during playback of real-time multimedia content of an existing channel that is provided from the content server.

The present invention further provides a method of changing channels in a content service system, which provides real-time multimedia content of a changed channel through an existing session without returning to a browser when a wireless communication terminal requests a channel change while providing real-time multimedia content of an existing channel to the wireless communication terminal.

Additional features of the invention will be set forth in the description which follows, and in part will be apparent from the description, or may be learned by practice of the invention.

The present invention discloses a method of changing channels in a wireless communication terminal, including: requesting real-time content of a first channel from a content service system; receiving the real-time content of the first channel through a session established with the content service system; requesting channel change from the content service system; and receiving real-time content of a second channel from the content service system through the session established with the content service system.

The present invention also discloses a method of changing channels in a content service system, including: receiving a request for real-time content of a first channel from a wireless communication terminal; establishing a session between the wireless communication terminal and a content server; providing the real-time content of the first channel through the session established between the wireless communication terminal and the content server; and providing real-time content of a second channel to the wireless communication terminal through the session established between the wireless communication terminal and the content server.

The present invention also discloses a content service system having a channel change function, including: a wireless communication terminal to transmit a channel change request; and a content server to establish a session with the wireless communication terminal and to provide real-time content of a first channel and real-time content of a second channel to the wireless communication terminal through the session.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a method of changing channels according to the related art.

FIG. 2 shows a method of changing channels according to an exemplary embodiment of the present invention.

FIG. 3 illustrates a channel change state according to an exemplary embodiment of the present invention.

FIG. 4 shows a packet that is used to change channels according to an exemplary embodiment of the present invention.

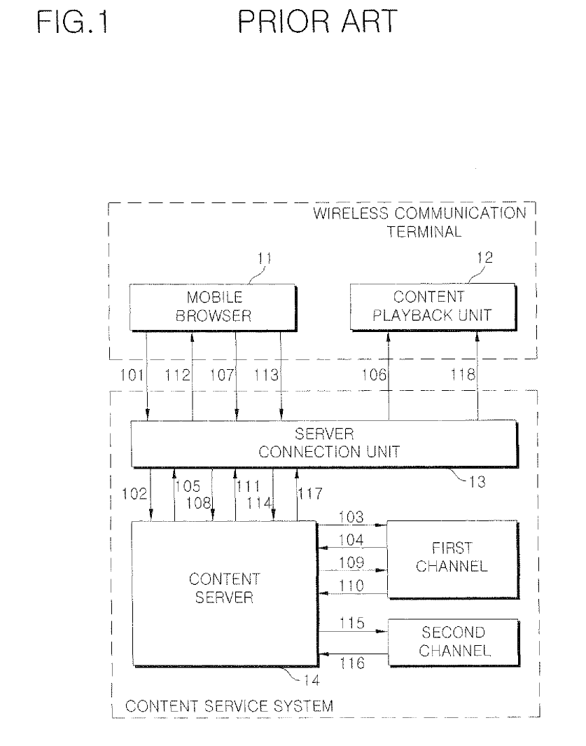

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

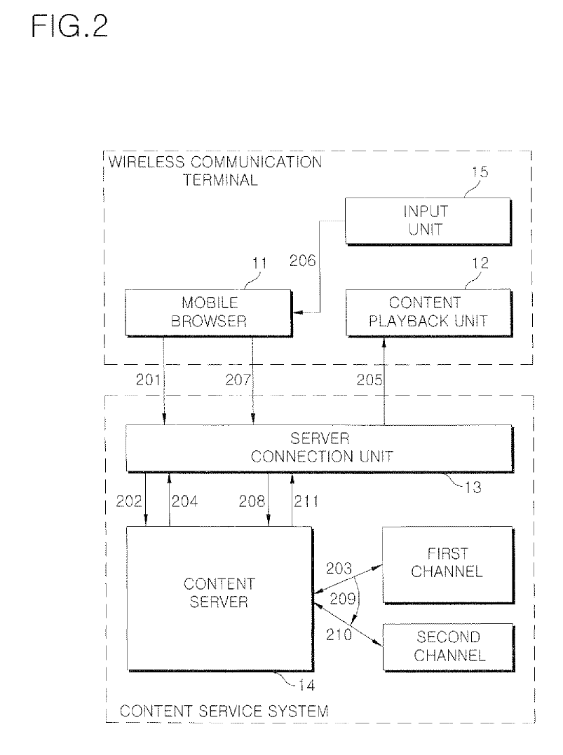

FIG. 2 shows a method of changing channels according to an exemplary embodiment of the present invention.

A wireless communication terminal of the exemplary embodiment may include a mobile browser 11, a content playback unit 12, and an input unit 15. When a user requests real-time multimedia content of a first channel from a wireless communication terminal, the wireless communication terminal requests the real-time multimedia content of the first channel from a content service system (201).

A server connection unit 13 incorporated in the content service system receiving the request of the wireless communication terminal establishes a session between the wireless communication terminal and a content server 14 (202). The content server 14 receives the real-time multimedia content of the first channel (203), sends the real-time multimedia content of the first channel to the server connection unit 13 (204), and the server connection unit 13 sends the real-time multimedia content of the first channel to the content playback unit 12 (205) during the first session.

When the wireless communication terminal is requested from the user to change the channel through an input unit 15 (206), the wireless communication terminal requests a channel change from the content service system (207). At this time, the wireless communication terminal maintains the session with the content service system. That is, the wireless communication terminal does not terminate a session and does not stop playing the multimedia content being currently played (205).

The content service system provides the real-time multimedia content of the first channel and then provides the real-time multimedia content of the second channel to the wireless communication terminal without terminating the session between the wireless communication terminal and the content service system.

Real-time multimedia content input to the content server 14 switches from the first channel to the second channel (209), and the content server 14 begins receiving the real-time multimedia content of a second channel (209 and 210). The content server 14 transmits the requested real-time multimedia content of a second channel to the server connection unit 13 (211).

The server connection unit 13 provides the real-time multimedia content of second channel transmitted from the content server 14 to the wireless communication terminal during the existing first session (205).

The wireless communication terminal switches from playing the real-time multimedia content of first channel to playing the real-time multimedia content of second channel without terminating the first session.

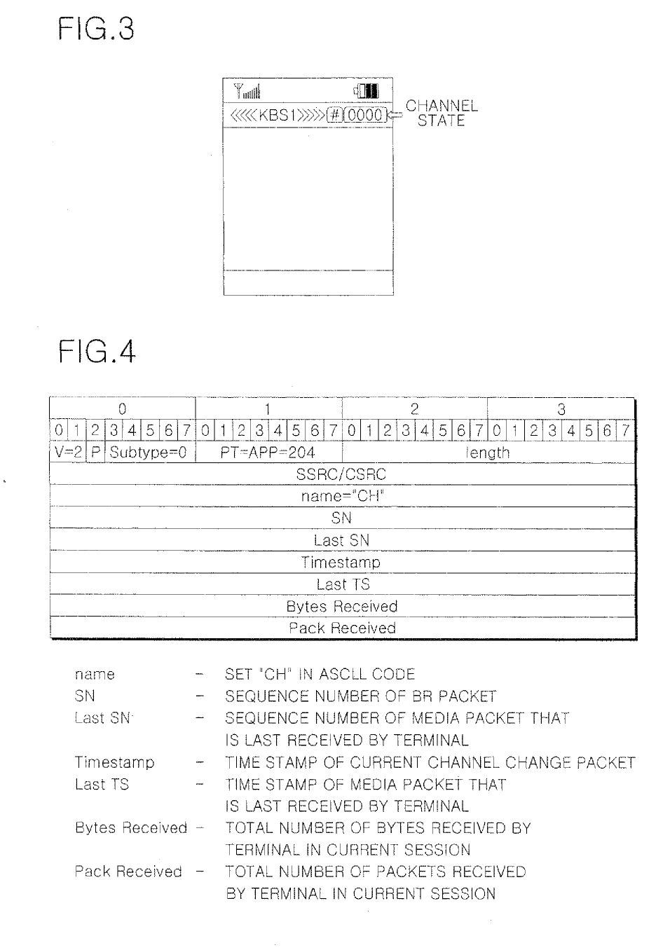

Since the existing first session is not terminated upon changing the channel, the wireless communication terminal does not return to the browser. The wireless communication terminal promptly changes to a desired channel by using information inputted through the input unit 15 as shown in FIG. 3.

Even though a single content server 14 has been described in the present embodiment, multiple content servers may also be employed. For example, the server connection unit 13 may store content information of individual channels managed by the individual content servers 14, which may be coupled with the server connection unit 13 via a network or a wireless network.

Accordingly, when the server connection unit 13 receives channel connection request from the wireless communication terminal, the server connection unit 13 may search for a content server to be coupled with the wireless communication terminal. An existing first session established between the server connection unit 13 and the wireless communication terminal is maintained even though the content server may be changed from a first content server to a second content server.

The method of changing channels according to the present embodiment of the invention will be described in more detail.

The wireless communication terminal transmits a packet shown in FIG. 4 to the content server 14 at regular intervals or if requested.

For example, a packet related to billing may be periodically sent to the content server 14 to report the amount of information of the content server 14 that is received by the wireless communication terminal. As another example, when the session needs to be completely released or temporarily interrupted, a packet containing a release or interruption request may be sent to the content server 14.

In these instances, additional information may be assigned in a header of a packet transmitted from the wireless communication terminal to the server. In this case, when channel information required by the wireless communication terminal is optionally added, the content server 14 or another component in the content service system may confirm that there is information concerning channel change request by parsing the header of the packet received from the wireless communication terminal.

At this time, the terminal and the server do not release PPP connection with a socket maintaining the existing session. The content server transmits content of the changed channel to the terminal.

For example, the channel change information may use Application-defined Real-time Transport Control Protocol (RTCP) Packets (APP) (as described in RFC 1889 Paragraph 6.6). Packets related to the channel change may be transmitted with audio and video through APP.

The above-mentioned method according to the present embodiment of the invention may be stored in any form of recording media, such as CD-ROM, RAM, ROM, floppy disk, hard disk, or magneto-optical disk, or in any computer-readable form, such as computer code organized into executable programs. A description of a method of storing an exemplary embodiment of the present invention is well known in the art and will be omitted.

As apparent from the above description, since the wireless communication terminal receives and outputs real-time multimedia content of a changed channel through an existing session with the content server without returning to the browser upon receipt of a channel change request from a user during playback of real-time multimedia content of an existing channel that is provided from the content server, it is possible to reduce the time required to provide the real-time multimedia content and to prevent limited resources of the wireless communication terminal from being wasted.

In addition, since the content service system provides real-time multimedia content of a changed channel through an existing session without returning to the browser upon receipt of a channel change request from the wireless communication terminal during providing real-time multimedia content of an existing channel to the wireless communication terminal, it is possible to reduce the time required to provide multimedia content and to prevent limited resources of the content service system from being wasted.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for changing channels in a wireless communication terminal, comprising:
requesting real-time content of a first channel from a content service system;
receiving the real-time content of the first channel through a session established with the content service system;
requesting channel change from the content service system; and
receiving real-time content of a second channel from the content service system through the session established with the content service system.

2. The method of claim 1, wherein the operation of requesting channel change comprises maintaining the session established with the content service system without returning to a browser.

3. The method of claim 1, wherein the operation of receiving real-time content of a second channel comprises stopping the real-time content of the first channel and playing the real-time content of the second channel.

4. The method of claim 1, wherein the real-time content comprises multimedia content.

5. The method of claim 1, wherein the real-time content comprises Digital Multimedia Broadcasting content.

6. The method of claim 1, wherein the real-time content comprises Video On Demand content.

7. A method for changing channels in a content service system, comprising:
receiving a request for real-time content of a first channel from a wireless communication terminal;
establishing a session between the wireless communication terminal and a content server;
providing the real-time content of the first channel through the session established between the wireless communication terminal and the content server;
receiving a request for a channel change from the wireless communication terminal; and
providing real-time content of a second channel to the wireless communication terminal through the session established between the wireless communication terminal and the content server.

8. The method of claim 7, wherein providing real-time content of a second channel further comprises:
terminating a connection between a server connection unit of the content service system and the first channel;
establishing a connection between the server connection unit and the second channel; and
transmitting the real-time content of the second channel to the server connection unit.

9. The method of claim 8, wherein the server connection unit stores information related to real-time content available on channels corresponding to a plurality of content servers.

10. The method of claim 8, wherein receiving a request for a channel change comprises:
receiving a channel connection request;
searching for a content server corresponding to a channel identified in the channel connection request;
connecting the wireless communication terminal to the content server corresponding to the channel identified in the channel connection request through the session established between the wireless communication terminal and the content server.

11. The method of claim 7, further comprising:
transmitting a packet to the content server.

12. The method of claim 7, wherein the real-time content comprises multimedia content.

13. The method of claim 7, wherein the real-time content comprises Digital Multimedia Broadcasting content.

14. The method of claim 7, wherein the real-time content comprises Video On Demand content.

15. A content service system having a channel change function, comprising:
a wireless communication terminal to transmit a channel change request; and
a content server to establish a session with the wireless communication terminal and to provide real-time content of a first channel and real-time content of a second channel to the wireless communication terminal through the session.

16. The content service system of claim 15, further comprising:
a server connection unit to store information related to real-time content available on channels corresponding to a plurality of content servers.

17. The content service system of claim 16, wherein when a channel change request is received from the wireless communication terminal, the server connection unit searches for a content server corresponding to a requested channel and connects the wireless communication terminal to the content server that corresponds to the requested channel through the session.

18. The content service system of claim 16, wherein the server connection unit transmits a packet to the content server at regular intervals to maintain the session with the wireless communication terminal.

19. The content service system of claim 15, wherein the real-time content comprises multimedia content.

20. The content service system of claim 15, wherein the real-time content comprises Digital Multimedia Broadcasting content.

21. The content service system of claim 15, wherein the real-time content comprises Video On Demand content.
